(19) United States
(12) Patent Application Publication
(10) Pub. No.: US 2005/0170844 A1
(43) Pub. Date: Aug. 4, 2005

(54) Determination to request mobile station position through employment of call characteristics

(76) Inventors: Deborah Lewandowski Barclay, Winfield, IL (US); Christopher Lawrence Fernandez, Aurora, IL (US); Michael Antwong Garner, Roswell, GA (US); John J. MacNamara, Orland Park, IL (US); Stinson Samuel Mathai, Wheaton, IL (US); Christopher B. Mosby, Bolingbrook, IL (US)

Correspondence Address: PATTI & BRILL, ONE NORTH LASALLE STREET, 44TH FLOOR, CHICAGO, IL, 60602, US

(21) Appl. No.: 10/768,431

(22) Filed: Jan. 30, 2004

(51) Int. Cl. H04Q 7/20

(52) U.S. Cl. 455/456.1; 455/456.5

(57) ABSTRACT

A network component of an apparatus in one example employs one or more call characteristics to make a determination to initiate a request for one or more positions of one or more mobile stations.

### TECHNICAL FIELD

The invention relates generally to networks and more particularly to monitoring a cellular network.

### BACKGROUND

Mobile Switching Centers (“MSC”) monitor and record data associated with cellular traffic or with mobile stations within cells of cellular networks. A Mobile Switching Center in one example correlates the data with one or more positions of one or more mobile stations within a cellular network cell. The Mobile Switching Center in one design continuously determines the positions of the mobile stations within a cellular network cell. As one shortcoming, continuously determining the positions of the mobile stations is a resource intensive operation. As the number of mobile stations on a cellular network cell increases, the MSC allocates additional resources to determine the positions of the increased number of mobile stations.

Therefore, a need exists for promoting a reduction of allocation resources.

### SUMMARY

The invention in one implementation encompasses an apparatus. The apparatus comprises a network component that employs one or more call characteristics to make a determination to initiate a request for one or more positions of one or more mobile stations.

Another implementation of the invention encompasses a method. A request for one or more positions of one or more mobile stations is initiated through employment of one or more call characteristics.

Yet another implementation of the invention encompasses an article. The article comprises one or more computer-readable signal-bearing media. The article comprises means in the one or more media for initiating a request for one or more positions of one or more mobile stations through employment of one or more call characteristics.

### DESCRIPTION OF THE DRAWINGS

Features of exemplary implementations of the invention will become apparent from the description, the claims, and the accompanying drawings in which:

FIG. 1 is a representation of one exemplary implementation of an apparatus that comprises one or more mobile stations, one or more cells, one or more base stations, one or more switch components, one or more network components, one or more position components, and one or more service providers.

FIG. 2 is a representation of an exemplary process flow of an initiation of a request for one or more positions of the one or more mobile stations of the apparatus of FIG. 1.

FIG. 3 is a representation of another exemplary process flow of an initiation of a request for one or more positions of the one or more mobile stations of the apparatus of FIG. 1.

### DETAILED DESCRIPTION

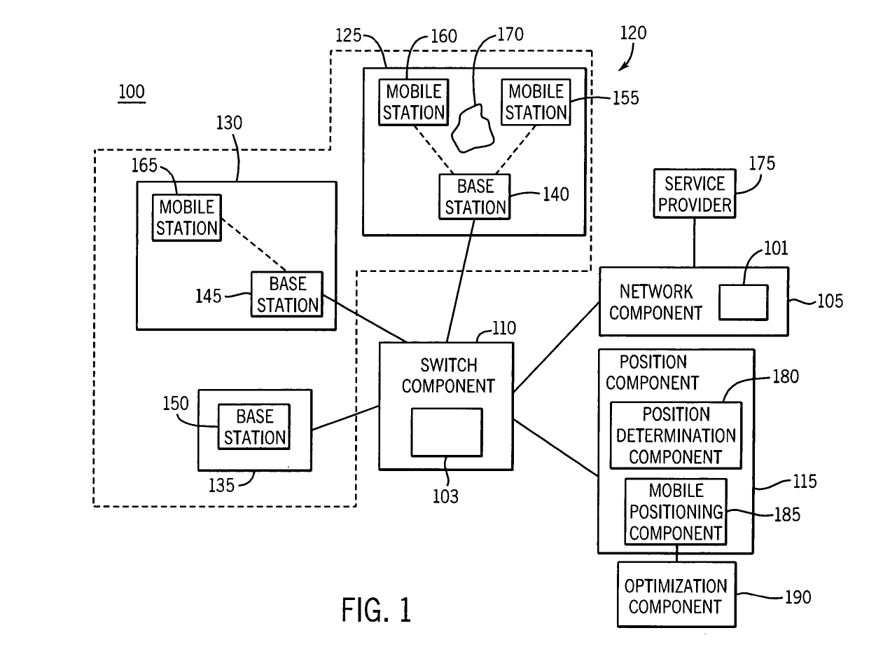

Turning to FIG. 1, an apparatus 100 in one example comprises one or more network components 105, one or more switch components 110, one or more position components 115, and one or more networks 120. The network component 105 in one example comprises a recordable data storage medium of the network component. The switch component 110 comprises a telephony switch, for example, a mobile switching center (“MSC”). The position component 115 in one example comprises a position determination component 180 and a mobile positioning component 185. The network component 105 communicates with the switch component 110. The switch component 110 in one example communicates with the position component 115. The switch component 110 communicates with the network 120 to receive one or more call characteristics of one or more mobile stations on the network 120.

The network 120 in one example comprises a cellular network that is owned and/or operated by one or more service providers, for example, a service provider 175. The network 120 in one example comprises one or more cellular network cells 125, 130, and 135. The cellular network cells 125, 130 and 135 in one example comprise one or more base stations 140, 145, and 150, as will be appreciated by those skilled in the art. The cellular network cells 125, 130, and 135 in one example comprise one or more portions of a geographic area in a cellular network, for example, the network 120. The base stations 140, 145, and 150, provide service to one or more mobile stations 155, 160, and/or 165 within the cellular network cells 125, 130, and 135. For example, the base station 140 provides service to the mobile station 155 for incoming and outgoing calls to/from the mobile station 155.

The mobile stations 155, 160, and 165 in one example comprise one or more mobile telephony devices. For example, the mobile stations 155, 160, and/or 165 comprise one or more of: a cellular phone, a pager, a mobile computer, and a wireless personal assistant. The mobile stations 155, 160, and/or 165, in one example communicate with one or more of the base stations 140, 145, and/or 150, to initiate and/or receive one or more calls. The base stations 140, 145, and/or 150 in one example communicate with the switch component 110 to route one or more calls on the network 120, as will be appreciated by those skilled in the art.

The network component 105 in one example makes a determination to initiate a request for one or more positions of one or more mobile stations through employment of one or more call characteristics. The network component 105 in one example receives one or more call characteristics from the switch component 110. The network component 105 in one example comprises an interface. The network component 105 in one example receives one or more thresholds from the service provider 175 through employment of an interface. The thresholds comprise maximum or minimum values. The service provider 175 in one example establishes the thresholds as a measure to indicate correct operation of the network 120 and to indicate a quality level of service is provided to the mobile stations 155, 160, and 165. In one example, the thresholds comprise one or more levels, that if exceeded, indicate one or more potential problems with the network 120, as will be appreciated by those skilled in the art. For example, the service provider 175 provides a dropped call threshold. If the dropped call threshold is exceeded, a “dead spot” on the network 120 may exist. In another example, the thresholds comprise one or more indicators associated with one or more mobile stations. For example, where the mobile station 165 is dropping calls within a geographic region of the cellular network cell 130 the service provider 175 provides a threshold, for example, a telephony number of the mobile station 165, to the network component 105. The network component 105 in one example employs the telephony number to make a determination to initiate a request for one or more positions of the mobile station 165.

The network component 105 in one example employs one or more call characteristics to create one or more call statistics. Call statistics in one example comprise one or more long term trends, such as a number of dropped calls in a period of time, as will be understood by those skilled in the art. In one example, the network component 105 performs a comparison of one or more call characteristics with one or more thresholds, for example, one or more call characteristic thresholds. In another example, the network component 105 performs a comparison of one or more call statistics with one or more thresholds, for example, one or more call statistic thresholds. The network component 105 makes a determination to initiate a request for one or more positions of the mobile stations 155, 160, and/or 165 where one or more call characteristics exceed one or more call characteristic thresholds and/or one or more call statistics exceed one or more call statistic thresholds. Where the call characteristics and/or the call statistics drop below the thresholds, the network component 105 discontinues a request for the one or more positions of the one or more mobile stations, for example, the mobile stations 155, 160, and/or 165. The network component 105 promotes an avoidance in congestion in one or more cellular network communication paths of the network 120 by qualifying the determinations to initiate the requests, as will be appreciated by those skilled in the art.

The network component 105 serves to limit a number of requests for one or more positions of the mobile stations 155, 160, and/or 165 by performing a comparison of one or more call characteristics with one or more thresholds. When the call characteristics exceed the thresholds, the network component 105 makes a determination to initiate a request for the positions. In one example, the service provider 175 establishes the one or more thresholds to indicate a problem may exist on the network 120 where the thresholds are exceeded. The network component 105 employs one or more call characteristics and one or more thresholds to provide for an automatic network optimization by identifying one or more potential problems. The network component 105 employs the thresholds established by the service provider 175 to automatically initiate a request for one or more positions of the mobile stations 155, 160, and/or 165.

The network component 105 selects one or more mobile stations 155, 160, and/or 165, and/or one or more of the cellular network cells 125, 130, and/or 135 for which to initiate a request for one or more positions of one or more of the mobile stations 155, 160, and 165. In one example, the network component 105 employs one or more call parameters to identify the mobile stations 155, 160, and/or 165. In another example, the network component 105 employs one or more call parameters to identify one or more of the cellular network cells 125, 130, and 135.

In one example, the network component 105 makes a determination that a call characteristic, for example, a pilot signal strength characteristic, associated with the mobile station 160 exceeds a call characteristic threshold, for example, a pilot signal strength threshold. The network component 105 initiates a request for one or more positions of the mobile station 165. The network component 105 formulates the request for the positions of the mobile station 165 with a call parameter, for example, a telephony number associated with the mobile station 165.

In another example, the network component 105 makes a determination that a call statistic, for example, a number of dropped calls within an hour, exceeds a dropped call statistic threshold for the cellular network cell 125. The network component 105 initiates a request for one or more positions of one or more mobile stations within the geographic region of the cellular network cell 125. The network component 105 formulates the request for the one or more positions of the one or more mobile stations within the cellular network cell 125 with a cell identifier associated with the cellular network cell 125. The network component 105 in one example receives one or more positions of the mobile stations 155 and 160 within the cellular network cell 125. The network component 105 in one example develops a coverage map based on the call statistic, the dropped call statistic threshold, and the one or more positions of the mobile stations 155 and 160.

The switch component 110 communicates with the mobile stations 155, 160, and/or 165 through employment of the base stations 140, 145, and/or 150 to receive one or more call characteristics associated with one or more of the mobile stations 155, 160, and 165. For example, the switch component 110 receives a pilot signal strength characteristic associated with a signal from the mobile station 155, as will be appreciated by those skilled in the art. The switch component 110 in one example provides one or more call characteristics to the network component 105.

The network component 105 provides one or more requests to the switch component 110 to determine one or more positions of the mobile stations 155, 160, and/or 165. The requests in one example comprise one or more call parameters. The switch component 110 employs one or more call parameters to identify one or more mobile stations for which to obtain the positions. Where a mobile station, for example, the mobile station 155, satisfies one or more of the call parameters, the switch component 110 cooperates with the position component 115 to determine one or more positions of the mobile station 155.

The switch component 110 and the position component 115 cooperate to determine one or more positions of one or more of the mobile stations 155, 160, and 165, at one or more intervals of time. In one example, the switch component 110 instructs the position component 115 to determine a position of the mobile station 155 every five minutes. In another example, the switch component 110 instructs the position component 115 to continuously determine the positions of the mobile stations 155 and 160. In yet another example, the position component 115 is pre-provisioned with one or more intervals of time to determine one or more positions of the mobile station 165.

In one example, the switch component 110 receives one or more positions of one or more mobile stations from the position component 115. The switch component 110 in one example develops a coverage map based on the one or more positions of the mobile stations 155, 160, and/or 165 and one or more call characteristics. In another example, the switch component 110 provides one or more positions of the mobile stations 155, 160, and/or 165 to the network component 105. The network component 105 in one example develops a coverage map. The service provider 175 in one example employs the coverage map to provide for one or more network optimizations. For example, the service provider 175 employs the coverage map to determine that a dead zone (for example, a zone of little or no cellular service) exists within a geographic region, for example, a geographic region 170, of the cellular network cell 125. The service provider 175 in one example employs the coverage map to recommends an addition of a base station within the geographic region 170 of the cellular network cell 125.

The position component 115 in one example obtains one or more positions of one or more of the mobile stations 155, 160, and 165, through employment of one or more position determination algorithms. For example, the position component 115 employs an IS-801 solution using an Assisted Global Positioning System (“AGPS”), Advanced Forward Link Trilateration (“AFLT”) or combined AGPS/AFLT algorithm or an Enhanced Forward Link Trilateration (“EFLT”) algorithm. The position determination component 180 in one example determines a position determination algorithm to employ in obtaining a position of the mobile station 165. The mobile positioning component 185 in one example provides GPS assistance data that is sent to the mobile to aid the mobile in the detection of GPS signals. The mobile positioning component 185 collects the GPS measurements and pilot signaling measurements made by the mobile.

In one example, the position component 115 provides one or more positions of one or more of the mobile stations 155, 160, and 165, to the switch component 110. In another example, the position component 115 provides one or more positions of one or more of the mobile stations 155, 160, and 165 to an optimization component 190. The optimization component 190 generates one or more network optimization reports. The service provider 175 in one example employs the network generation reports to identify one or more dead spots on the network 120. In yet another example, the position component 115 provides one or more positions of one or more mobile stations to the network component 105.

An illustrative description of exemplary operation of the apparatus 100 is presented, for explanatory purposes.

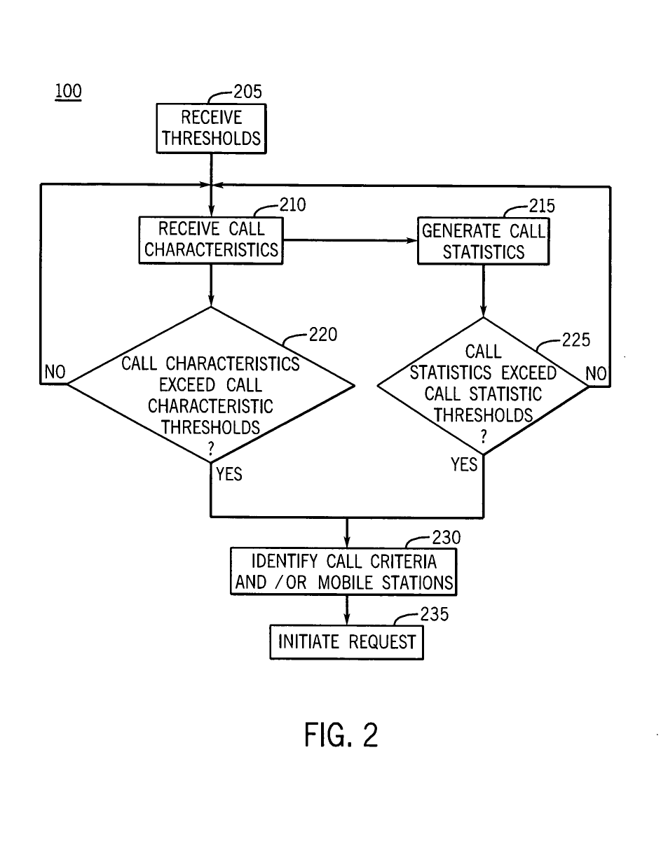

Turning to FIG. 2, the network component 105 makes a determination to initiate a request for one or more positions of one or more mobile stations within one or more of the one or more cells on the network 120. In STEP 205, the network component 105 receives one or more call characteristics thresholds and one or more call statistic thresholds from the service provider 175 of the network 120. In STEP 210, the network component 105 receives one or more call characteristics from the switch component 110. In STEP 215, the network component 105 creates one or more call statistics from the one or more call characteristics. In STEP 220, the network component 105 performs a comparison of the call characteristics to the call characteristic thresholds. In STEP 225, the network component 105 performs a comparison of the call statistics to the call statistic thresholds.

If the network component 105 determines that the call characteristics exceed the call characteristic thresholds and/or the call statistics exceed the call statistic thresholds, the network component 105 identifies one or more call parameters associated with the call characteristic thresholds and/or the call statistic thresholds (STEP 230). The network component 105 formulates the request based on the one or more call parameters. In STEP 235, the network component 105 sends the request to the switch component 110.

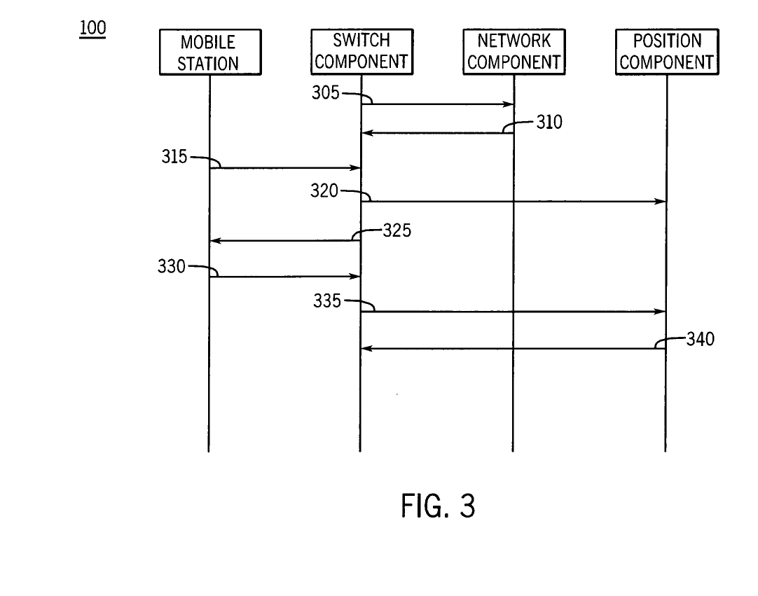

Turning to FIG. 3, the network component 105 employs a pilot signal strength characteristic and a pilot signal strength threshold to make a determination to initiate a request for a position of the mobile station 155 when initiating an outgoing call. In STEP 305, the network component 105 receives the pilot signal strength characteristic associated with the mobile station 155 from the switch component 110. In STEP 310, the network component 105 compares the pilot signal strength characteristic to the pilot signal strength threshold. The network component 105 determines that the pilot signal strength characteristic exceeds the pilot signal strength threshold. The network component 105 makes a determination to initiate a request for a position of the mobile station 155 to the switch component 110. The network component 105 provides a telephony number associated with the mobile station 155.

In STEP 315, the switch component 110 receives a request to initiate a call from the mobile station 155. The switch component 110 compares a calling party number of the request to initiate the call with the call parameter. In STEP 320, the switch component 110 instructs the position component 115 to determine the position of the mobile station 155. In STEP 325, the switch component 110 assigns a channel to the mobile station 155 for the call.

In STEP 330, the position component 115 provides the position of the mobile station 155 to the switch component 110.

The apparatus 100 in one example comprises a plurality of components such as computer software and/or hardware components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs at least one computer-readable signal-bearing medium. One example of a computer-readable signal-bearing medium for the apparatus 100 comprises an instance of a recordable data storage medium such as one or more of a magnetic, electrical, optical, biological, and atomic data storage medium. The recordable data storage medium in one example comprises the storage devices 101 and 103. In another example, a computer-readable signal-bearing medium for the apparatus 100 comprises a modulated carrier signal transmitted over a network comprising or coupled with the apparatus 100, for instance, one or more of a telephone network, a local area network (“LAN”), the Internet, and a wireless network. An exemplary component of the apparatus 100 employs and/or comprises a set and/or series of computer instructions written in or implemented with any of a number of programming languages, as will be appreciated by those skilled in the art.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
a network component that employs one or more call characteristics to make a determination to initiate a request for one or more positions of one or more mobile stations.

2. The apparatus of claim 1, wherein the network component performs a comparison of the one or more call characteristics with one or more thresholds to make the determination to initiate the request for the one or more positions of the one or more mobile stations.

3. The apparatus of claim 2, wherein the one or more call characteristics comprise a pilot signal strength characteristic, wherein the one or more thresholds comprise a pilot signal strength threshold, wherein the network component performs a comparison of the pilot signal strength characteristic with the pilot signal strength threshold;
wherein the network component makes the determination to initiate the request for the one or more positions of the one or more mobile stations based on a result of the comparison of the pilot signal strength characteristic with the pilot signal strength threshold.

4. The apparatus of claim 2, wherein the network component employs the one or more call characteristics to create one or more call statistics, wherein the one or more thresholds comprise one or more call characteristic thresholds and one or more call statistic thresholds;
wherein the network component performs a comparison of the one or more call statistics with the one or more call statistic thresholds;
wherein the network component employs a comparison of the one or more call characteristics with the one or more call characteristic thresholds and the comparison of the one or more call statistics with the one or more call statistic thresholds to make the determination to initiate the request.

5. The apparatus of claim 2, wherein the network component comprises an interface, wherein the network component receives the one or more thresholds from a service provider through employment of the interface.

6. The apparatus of claim 1, wherein the network component employs the determination to initiate the request to promote an avoidance of congestion in one or more cellular network communication paths.

7. The apparatus of claim 6, wherein the network component makes the determination to initiate the request upon an exceedance of the one or more call characteristics relative to one or more thresholds;
wherein upon the exceedance of the one or more call characteristics relative to the one or more thresholds, the network component and a position component cooperate to obtain the one or more positions of the one or more mobile stations.

8. The apparatus of claim 7, wherein upon a termination of the exceedance of the one or more call characteristics relative to the one or more thresholds, the network component and the position component cooperate to discontinue attainment of the one or more positions of the one or more mobile stations.

9. The apparatus of claim 1, wherein the network component employs the one or more call characteristics to perform a selection of the one or more mobile stations from a plurality of mobile stations;
wherein the network component employs the selection to formulate the request for the one or more positions of the one or more mobile stations from the plurality of mobile stations.

10. The apparatus of claim 1, wherein the one or more mobile stations are associated with one or more cellular network cells;
wherein the network component employs the one or more call characteristics to perform a selection of the one or more cellular network cells from a plurality of cellular network cells;
wherein the network component employs the selection to formulate the request for the one or more positions of the one or more mobile stations that are associated with the one or more cellular network cells.

11. The apparatus of claim 10, wherein the network component employs a switch component to identify the one or more mobile stations that are associated with the one or more cellular network cells;
wherein the network component employs the switch component to determine the one or more positions of the one or more mobile stations that are associated with the one or more cellular network cells.

12. The apparatus of claim 1, wherein the network component receives the one or more positions of the one or more mobile stations in response to the request;
wherein the network component employs the one or more positions of the one or more mobile stations and the one or more call characteristics to develop a coverage map.

13. The apparatus of claim 1, further comprising:
a switch component that provides the one or more call characteristics to the network component;
wherein the network component employs the one or more call characteristics to make a determination to initiate a request to the switch component;
wherein the switch component obtains the one or more positions of the one or more mobile stations based on the request to the switch component.

14. The apparatus of claim 13, wherein the network component provides to the switch component one or more call parameters;
wherein the switch component employs the one or more call parameters to perform an identification of the one or more mobile stations from a plurality of mobile stations;
wherein the switch component employs the identification of the one or more mobile stations from the plurality of mobile stations to obtain the one or more positions of the one or more mobile stations.

15. The apparatus of claim 14, wherein the one or more mobile stations are associated with one or more calls;
wherein the switch component employs the one or more call parameters to perform an identification of the one or more calls from a plurality of calls;
wherein the switch component employs the identification of the one or more calls from the plurality of calls to obtain the one or more positions of the one or more mobile stations that are associated with the one or more calls.

16. The apparatus of claim 13, wherein the network component and the switch component receive the one or more positions of the one or more mobile stations from a position component;
wherein the network component and the switch component cooperate to develop a coverage map through employment of the one or more positions of the one or more mobile stations.

17. The apparatus of claim 16, wherein the position component employs one or more of an Enhanced Forward Link Trilateration algorithm and an IS-801 solution using an Assisted Global Positioning System (AGPS), Advanced Forward Link Trilateration (AFLT) or combined AGPS/AFLT algorithm to determine the one or more positions of the one or more mobile stations.

18. A method, comprising the step of:
initiating a request for one or more positions of one or more mobile stations through employment of one or more call characteristics.

19. The method of claim 18, wherein the step of initiating the request for the one or more positions of the one or more mobile stations through employment of the one or more call characteristics comprises the steps of:
performing a comparison of the one or more call characteristics with one or more thresholds; and
initiating the request for the one or more positions of the one or more mobile stations based on the comparison.

20. The method of claim 19, wherein the step of initiating the request for the one or more positions of the one or more mobile stations based on the comparison comprises the steps of:
determining one or more call parameters associated with the one or more thresholds;
identifying the one or more mobile stations from a plurality of mobile stations through employment of the one or more call parameters; and
initiating the request for the one or more positions of the one or more mobile stations through employment of the one or more call parameters.

21. An article, comprising:
one or more computer-readable signal-bearing media;
means in the one or more media for initiating a request for one or more positions of one or more mobile stations through employment of one or more call characteristics.
